(19) United States
(12) Patent Application Publication
(10) Pub. No.: US 2008/0201776 A1
(43) Pub. Date: Aug. 21, 2008

(54) Method And Computing System For Avoiding Denial Of Service Attacks

(75) Inventors: Pavan Vamana Rao, Bangalore (IN); Arun Avanna Vijayakumar, Bangalore (IN); Arun Keshava Murthy, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett Packard Company, Fort Collins, CO (US)

(21) Appl. No.: 12/034,576

(22) Filed: Feb. 20, 2008

(30) Foreign Application Priority Data
Feb. 21, 2007 (IN) 346/CHE/2007

(51) Int. Cl. G06F 21/00

(52) U.S. Cl. 726/22

(57) ABSTRACT

A computing system configured to receive service requests, comprising a memory for storing service request data and a service request handler. The computing system is configured to respond to a service request by registering a call back routine configured to pass details of the service request to the memory if executed by a panic process upon a system crash, the memory is configured to store the details of the service request passed to it, and the service request handler is configured to compare the service request to the service request data in the memory and to deny the service request if the service request matches a predefined portion of the service request data.

### RELATED APPLICATIONS

This patent application claims priority to Indian patent application serial no. 346/CHE/2007, titled “Method and Computing System for Avoiding Denial of Service Attacks”, filed in India on 21 Feb. 2007, commonly assigned herewith, and hereby incorporated by reference.

### BACKGROUND OF THE INVENTION

In a client-server environment, there may be thousands of clients requesting service from a server. For example, a file sharing service provided by an NFS server over the internet may receive thousands of such requests per minute, from clients with diverse geographical locations. A malicious request from a client or an improperly implemented client could bring the server down, leading to a denial of service to the other clients. If malicious, such a request constitutes a Denial of Service (DOS) attack.

One existing response to such attacks includes performing a crash dump analysis to ascertain the client sending the malicious request. Subsequent requests from that client are declined. However, this approach requires an in-depth crash dump analysis, and in any event this solution can be circumvented by the party responsible for the attack by merely changing the IP address of the client.

Another existing approach is to snoop for packets for a predefined time interval, to detect such attack requests based on data known to be associated with DOS attacks. This may also be used to avoid network congestion and hence avoid routers going down owing to heavy loads. This approach operates mainly at the router or gateway level. However, packet sniffing can be performed for a limited period, as constant packet sniffing greatly degrades server performance; hence, a malicious client request may be received at other times.

### BRIEF DESCRIPTION OF THE DRAWING

In order that the invention may be more clearly ascertained, embodiments will now be described, by way of example, with reference to the accompanying drawing, in which:

FIG. 1 is a schematic view of a RPC server according to an embodiment of the present invention.

FIG. 2 is a flow diagram of the method for avoiding service attached employed by the RPC server of FIG. 1 according to an embodiment of the present invention.

### DETAILED DESCRIPTION OF THE EMBODIMENTS

There will be provided a method for avoiding denial of service attacks.

In one embodiment, the method comprises responding to a service request by registering a call back routine configured to pass details of the service request to a memory if executed by a panic process upon a system crash, comparing the service request to service request data in the memory, and denying the service request if the service request matches a predefined portion of the service request data.

There will also be provided a computing system configured to receive service requests. In one embodiment, the computing system comprises a memory for storing service request data and a service request handler. The computing system is configured to respond to a service request by registering a call back routine configured to pass details of the service request to the memory if executed by a panic process upon a system crash, the memory is configured to store the details of the service request passed to it, and the service request handler is configured to compare the service request to the service request data in the memory and to deny the service request if the service request matches a predefined portion of the service request data.

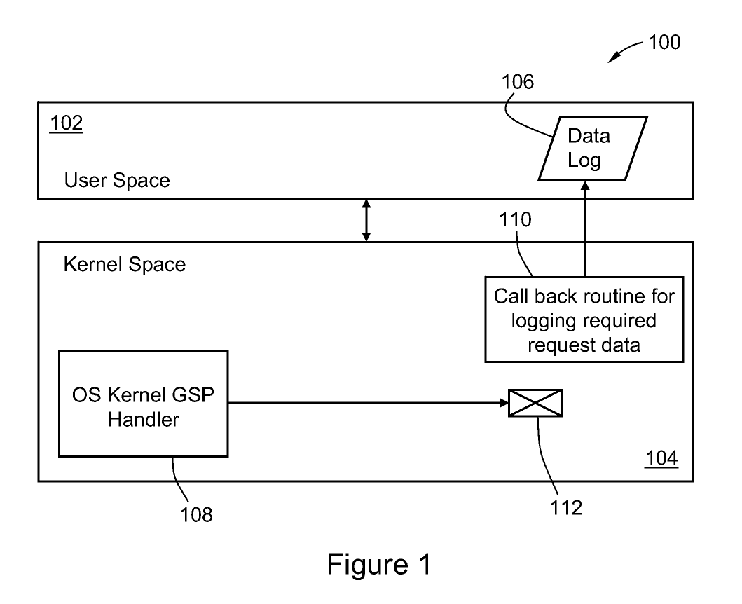

FIG. 1 is a schematic view of a computing system in the form of a RPC (Remote Procedure Call) server 100 according to an embodiment of the present invention. The RPC server 100 —for use with RPC clients—has a user space 102 and a kernel space 104. The user space includes a data log 106, in the form of a non-volatile memory, for logging particular data (described below) pertaining to service requests that cause a system crash. Kernel space 104 includes an OS kernel GSP (Generic Shutdown Path) Handler 108. RPC server 100 is an NFS server running HP-UX (not shown) but, as will be appreciated by those in the art, the present invention may also be readily implemented on other platforms.

RPC server 100 is configured to register, upon receiving a client request, a GSP call back routine 110 for saving details of the client, the requested procedure and any arguments to data log 106 if the RPC server 100 crashes while GSP Handler 108 is servicing the request. This data thus constitutes a “block list” and should be sufficient to allow the RPC server to distinguish unacceptable or malicious client requests from improper server implementation.

GSP call back routine 110 is registered by calling the routine gsp_register_callback( ) as follows:

gsp_register_callback(GSP_CRASH,
GSP_PANIC|GSP_MCA|GSP_HPMC|GSP_TOC,
GSP_REMOVE_CALLBACK, module_callback_fn, arg1, arg2);

This causes the call back routine 110 to be registered such that it will be called during the GSP_CRASH shutdown state and only if the system is going down either because of a panic or MCA or HPMC or TOC. It does not logs any details when the server is being gracefully shutdown.

RPC server 100 is configured, if such a crash occurs, to execute a panic process 112 that is configured to identify the registered call back routine 110 and execute it. The call back routine 110 thus logs the client and request information to data log 106.

In addition, GSP Handler 108 is configured to check each received client request against the contents of data log 106 before processing the request. GSP Handler 108 is configured to decline any client request that is similar to a request in the data log 106, as only client requests that caused a server crash have their details stored in the data log. Otherwise, if the check does not reveal a similarity between a new request and those detailed in the data log, the request is verified as valid and serviced by GSP Handler 108.

Thus, RPC server 100 can identify clients that are likely to attempt a DOS attack, and also to deny service to such clients or to client that make requests that are similar to earlier requests that are associated with a server crash.

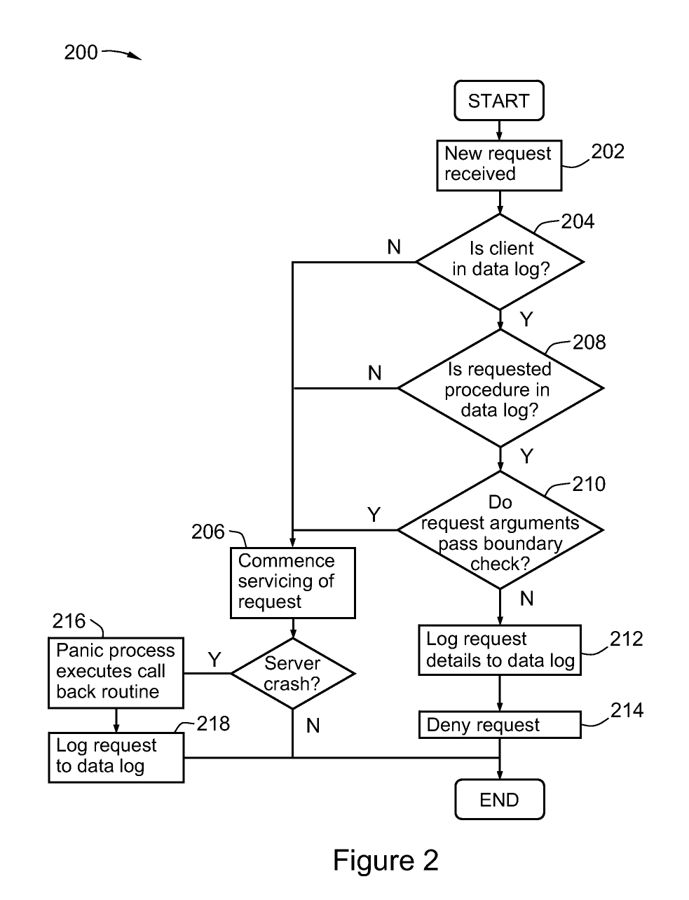

The method thus employed by RPC server 100 in normal operation is shown in flow diagram 200 of FIG. 2. It should be noted that the RPC server 100 will already have registered call back routine 110 (in case a server crash is caused by any subsequent client request) when the server was booted up.

Thus, at step 202, a new request is received by RPC server 100. At step 204, GSP Handler 108 checks whether the client making the request can be located in the data log 106. If not, the request is regarded as valid and processing continues at step 206 where the GSP Handler 108 commences servicing the client request.

If, at step 204, GSP Handler 108 ascertains that the client making the request is identified in data log 106, processing continues at step 208 where GSP Handler 108 checks whether the requested procedure is in data log 106 with a hashing technique for locating the requested procedure number. If not, the request is regarded as valid and processing continues at step 206 where the GSP Handler 108 commences servicing the client request.

If at step 208 GSP Handler 108 ascertains that the requested procedure is identified in data log 106, processing continues at step 210 where GSP Handler 108 checks whether the arguments in the client request pass a boundary check on the argument's values according to the content of data log 106.

If they do, the request is regarded as valid and processing continues at step 206 where the GSP Handler 108 commences servicing the client request. If they do not, processing continues at step 212 where the request's details are logged to data log 106. At step 214, the request is declined and processing ends.

As noted above, at step 206 the GSP Handler 108 commences servicing the client request. If the server crashes during the servicing of the client request, processing passes to step 216 where the panic process 112 executes call back routine 110 then, at step 218, call back routine 110 logs details of the client request to data log 106. Processing then ends.

Optionally, RPC server 100 may check whether malicious requests are coming from the same client repeatedly in a short period of time and, if so, deny all requests from that client system either by ignoring the requests or by informing the IDS that the client is malicious.

Furthermore, it should be noted that the present invention may be applied to any client server model, such as HTTP and FTP requests that may cause DOS attacks on a server.

The foregoing description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A computing system configured to receive service requests, comprising:
a memory for storing service request data; and
a service request handler;
wherein said computing system is configured to respond to a service request by registering a call back routine configured to pass details of said service request to said memory if executed by a panic process upon a system crash, said memory is configured to store said details of said service request passed to it, and said service request handler is configured to compare said service request to said service request data in said memory and to deny said service request if said service request matches a predefined portion of said service request data.

2. A computing system as claimed in claim 1, wherein said service request handler is further configured to pass details of said service request to said memory if said request is denied.

3. A computing system as claimed in claim 1, wherein said details of said service request passed to said memory include an origin of said service request, a requested procedure and any arguments of said requested procedure.

4. A computing system as claimed in claim 1, wherein said service request handler is configured to deny said service request if an origin of said service request and a requested procedure specified in said service request are located in said memory, and any arguments of said requested procedure fall outside acceptable ranges according to the content of said memory.

5. A method for avoiding denial of service attacks, comprising:
responding to a service request by registering a call back routine configured to pass details of said service request to a memory if executed by a panic process upon a system crash;
comparing said service request to service request data in said memory; and
denying said service request if said service request matches a predefined portion of said service request data.

6. A method as claimed in claim 5, further comprising passing details of said service request to said memory if said request is denied.

7. A method as claimed in claim 5, wherein said details of said service request passed to said memory include an origin of said service request, a requested procedure and any arguments of said requested procedure.

8. A computer readable medium provided with program data that, when executed on a computing system or systems, implements the method of claim 5.
